(19) United States
(12) Patent Application Publication
(10) Pub. No.: US 2007/0114449 A1
(43) Pub. Date: May 24, 2007

(54) STANDARD COMPONENT FOR LENGTH MEASUREMENT CALIBRATION, METHOD FOR MANUFACTURING THE SAME, AND CALIBRATION METHOD AND APPARATUS USING THE SAME

(76) Inventor: Yoshinori Nakayama, Sayama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/561,018

(22) Filed: Nov. 17, 2006

(30) Foreign Application Priority Data
Nov. 18, 2005 (JP) 2005-333565

(51) Int. Cl. G01N 23/00

(52) U.S. Cl. 250/491.1

(57) ABSTRACT

There is provided a standard component used in an electron beam system for performing length measurement calibration with high precision. A one-dimensional grating is disposed on a bonding wafer to enable high-precision calibration at the same height as that of a real wafer to be measured and calibration among systems. A high secondary electron signal intensity can be obtained by applying a constant voltage to the top silicon layer, thereby a good secondary electron signal image can be obtained with a weak electron beam. By disposing a one-dimensional grating on multiple locations on a wafer, calibration at each location on the wafer with a large diameter can be ensured.

### INCORPORATION BY REFERENCE

The present application claims priority from Japanese application JP 2005-333565 filed on Nov. 18, 2005, the content of which is hereby incorporated by reference into this application.

### BACKGROUND OF THE INVENTION

(1) Field of the Invention

The present invention relates to a linewidth calibration sample for electron beam systems used in manufacturing process of semiconductor integrated circuits and, in particular, to a calibration sample for high-precision electron beam metrology systems and a method for calibrating electron beam metrology systems.

(2) Description of Related Art

A stick-on standard sample is widely used for beam calibration of conventional electron beam systems, which is a standard component for calibration (standard sample) 26 having a one-dimensional grating pattern contained in a silicon chip and attached to a holder 27, which is then disposed on a stage 29 near a wafer under measurement, as described in JP-B2-3488745 and shown in FIG. 4. Another type is an embedded standard sample in which a chip is embedded in a recess formed in a wafer by machining with a height difference (between the wafer surface and chip surface) of approximately 10 μm as described in SPIE Microlithography 4689-59, 2002, and a brochure of VLSI Standard Inc.

As semiconductor devices are reduced in size, highly precise length measurement on such semiconductor devices is demanded. According to a conventional technique, a standard component is fixed in a position separate from a wafer on a sample stage as shown in FIG. 4, for example. A problem with the conventional technique is that one standard component cannot be shared among multiple systems without breaking the vacuum in the systems each time the sample is moved from one system to another and therefore inspection throughput is decreased. Therefore, a standard component is provided in each system and used for calibration of the system. However, because different standard components are used in the systems, variations in measurement precision among systems have resulted.

A standard component in which a recess is formed in a wafer consisting of a single silicon layer by machining and a calibration pattern (chip) is embedded in the recess as disclosed in SPIE Microlithography 4689-59, 2002, and a brochure of VLSI Standard Inc. can be taken out from a wafer transfer route without breaking vacuum and thus can be shared among multiple systems. However, the technique of embedding a calibration pattern in a single-silicon-layer wafer has a limitation of machining precision. The height difference precision is currently approximately 10 μm at best. Another problem with the technique is that there is an error in the levelness of the machined surface. If there is a difference in height between a wafer and a calibration pattern embedded in the wafer, that is, the difference in height between a wafer under measurement and a calibration pattern, the focal position of the electron beam system also differs between them, causing an error. If the height error is corrected by using a height sensor for example, degradation in the measurement precision caused by a calibration error of the height sensor cannot be avoided.

In addition, because conventional calibration components consist of a single silicon layer, degradation in calibration precision due to the effect of roughness associated with machining cannot be avoided. The problem of roughness becomes serious as the precision required of length measurement increases.

Furthermore, to perform calibration using a one-dimensional grating pattern, a sufficient secondary electron signal contrast between lines and grooves of the one-dimensional grating pattern is required. For example, if an ArF resist or low-k materials are used, an electron beam system must be calibrated with a current of approximately 5 pA or less. However, with such a low current, the intensity of a secondary electron signal decreases and therefore a sufficient contrast cannot be obtained. As a result the reproducibility of pitch measurement decreases.

An object of the present invention is to provide a standard sample for length measurement calibration and an electron beam system calibration method capable of calibrating an electron beam system with high precision.

### BRIEF SUMMARY OF THE INVENTION

To achieve the object as described above, a calibration pattern, preferably a one-dimensional grating pattern, that is arranged at a predetermined pitch is formed on a wafer having approximately the same thickness and diameter as a semiconductor wafer to be measured with an electron beam metrology system, and the calibration wafer (component for length measurement calibration) is placed in the electron beam metrology system to perform beam calibration. Because the calibration wafer has the same diameter as that of the wafer to be measured, the calibration wafer can be loaded on the stage through the same transfer system that is used for loading a wafer to be measured without the need for providing a separate vacuum transport system. Furthermore, because the same sample can be used for calibration of multiple machines, variations in the precision of length measurement can be reduced.

According to the present invention, the substrate used for fabricating a calibration component has a multilayer structure including at least a first material layer that is not tolerant to an etching agent and a second material layer that has a tolerance to the etching agent in order to maintain a certain height and resolution of a pattern. The substrate is preferably an SOI or silicon on insulator (bonding) substrate or a combination of an SOI (bonding) substrate and imprint transfer. With this calibration pattern formation, a uniform height can be produced and a calibration pattern with an ideal profile can be achieved because an oxide layer, which is an insulating material inside the SOI (bonding) substrate, acts as an etch stop layer.

A calibration mark containing a one-dimensional grating pattern is formed in a silicon layer, which is a conductive material layer on the top of an SOI (bonding) substrate, for example, and the substrate is irradiated with laser. As a result of the laser irradiation, the oxide film prevents thermal conduction, and surface melting of the one-dimensional diffraction reduces the surface roughness of the pattern. By grounding the top silicon layer or applying a certain voltage to the top silicon layer, the electric potential contrast between the top silicon layer and the underlying conductive material layer, for example a silicon layer, can be enhanced, a secondary electron image with a high signal-to-noise ratio can be obtained, and a highly precise calibration of an electron beam metrology system can be performed.

According to the present invention, there is provided a standard component for length measurement calibration, comprising a first substrate including at least a first material layer having a tolerance to a first etching process, a second material layer disposed on a surface of the first material layer and is etchable by the first etching process, and a third material layer disposed on the second material layer, having a tolerance to the first etching process, and is etchable by a second etching process, wherein the first substrate has a second substrate disposed thereon, the second substrate having a calibration pattern arranged at a predetermined pitch in a region etched by the first and second etching processes to a position at which the surface of the first material layer is exposed and where the surface of the third material layer is exposed.

According to the present invention, there is provided a method for calibrating an electron beam system having an electron source and scanning or irradiating a sample with an electron beam emitted from the electron source to measure a desired pattern on the sample, comprising: using a standard component for length measurement calibration to scan a correction pattern with the electron beam, the standard component having a correction pattern provided thereon, the correction pattern having grooves arranged at a predetermined pitch on a substrate including at least a first material layer and a second material layer disposed on a surface of the first material layer, the bottom of the grooves being the surface of the first material layer; and comparing a pitch obtained from a signal waveform of the obtained reflection electrons or secondary electrons with a pitch of the one-dimensional grating pattern.

According to the present invention, there is provided a method for calibrating an electron beams system having an electron source and scanning or irradiating a sample with an electron beam emitted from the electron source to measure a desired pattern on the sample, comprising: using a standard component for length measurement calibration to scan a correction pattern with the electron beam, the standard component having an opening on a surface of a first substrate including at least a first material layer and a second material layer disposed on a surface of the first material layer, the bottom of the opening being the surface of the first material layer, the calibration pattern being formed on a second substrate disposed on the bottom of the opening and being arranged at a predetermined pitch; comparing a pitch obtained from a signal waveform of the obtained reflection electrons or secondary electrons with a pitch of the one-dimensional grating pattern.

In the method for calibrating an electron beam system mentioned above, the standard component for length measurement calibration further comprises a third material layer disposed on the surface of the second material layer.

In the method for calibrating an electron beam system mentioned above, the calibration is performed with the third material layer being grounded or supplied with a given voltage.

In the method for calibrating an electron beam system mentioned above, the calibration is performed with the third material layer being insulated from a surrounding conductor.

According to the present invention, there is provided an electron beam system having at least an electron source, a deflection unit which scans a sample with an electron beam emitted from the electron source, and an object lens and measuring a desired pattern on the sample, the electron beam system comprising: a detector which uses a standard component for length measurement to detect reflection electrons or secondary electrons generated by scanning the calibration pattern with the electron beam, the standard component for length measurement calibration having a calibration pattern provided thereon, the calibration pattern having grooves arranged at a predetermined pitch on a substrate including at least a first material layer and a second material layer disposed on a surface of the first material layer, the bottom of the grooves being the surface of the first material layer; a calculation unit which calculates a pitch on the basis of a signal of the detected secondary electrons or reflection electrons; a comparison unit which compares the calculated pitch with a stored pitch of the one-dimensional grating pattern; and a calibration unit which calibrates a measured value on the basis of the result of the comparison.

According to the present invention, there is provided an electron beam system having at least an electron source, a deflection unit which scans a sample with an electron beam emitted from the electron source, and an object lens and measuring a desired pattern on the sample, the electron beam system comprising: a detector which uses a standard component for length measurement calibration to detect reflection electrons or secondary electrons generated by scanning a calibration pattern with the electron beam, the standard component having an opening on a surface of a first substrate including at least a first material layer and a second material layer disposed a surface of on the first material layer, the bottom of the opening being the surface of the first material layer, the calibration pattern being formed on a second substrate disposed on the bottom of the opening and being arranged at a predetermined pitch; a calculation unit which calculates a pitch on the basis of the detected secondary electrons and reflection electrons; a comparison unit which compares the calculated pitch with a stored pitch of the one-dimensional grating pattern; and a calibration unit which calibrates a measured value on the basis of the result of the comparison.

In the electron beam system mentioned above, the system further comprises a memory unit which stores a position at which the calibration is performed and a correction coefficient at the calibration position, and a control unit which controls correction of a measured value on the basis of the stored calibration position and correction coefficient.

In the electron beam system mentioned above, the system further comprises a third material layer disposed on the second material layer of the standard component for length measurement calibration.

In the electron beam system mentioned above, the standard component for length measurement includes the calibration pattern in a plurality of locations; and the memory unit stores a correction coefficient at each of the locations.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 shows a configuration of a system according to the present invention;

FIGS. 2A and 2B illustrate a standard component according to the present invention;

FIGS. 3A and 3B illustrate a standard component according to the present invention;

FIG. 4 shows a configuration of a conventional system;

FIG. 5 illustrates a cross-section of a standard component according to the present invention;

FIG. 6 illustrates a cross-section of a conventional standard component;

FIG. 7 illustrates a calibration procedure according to the present invention;

FIG. 8 illustrates a calibration method according to the present invention;

FIGS. 9A-9E illustrate a process for fabricating a standard component according to the present invention;

FIGS. 10A-10D illustrate a process for fabricating a standard component according to the present invention;

FIG. 11 illustrates a device production flow and systems used;

FIG. 12 shows an example of a device production flow and systems used according to the present invention;

FIG. 13 shows an example of an inspection system in which a calibration component according to the present invention is used; and

FIG. 14 shows an example of an inspection system in which a calibration component according to the present invention is used.

### DETAILED DESCRIPTION OF THE INVENTION

Specific examples of the present invention will be described below with reference to the accompanying drawings.

### FIRST EXAMPLE

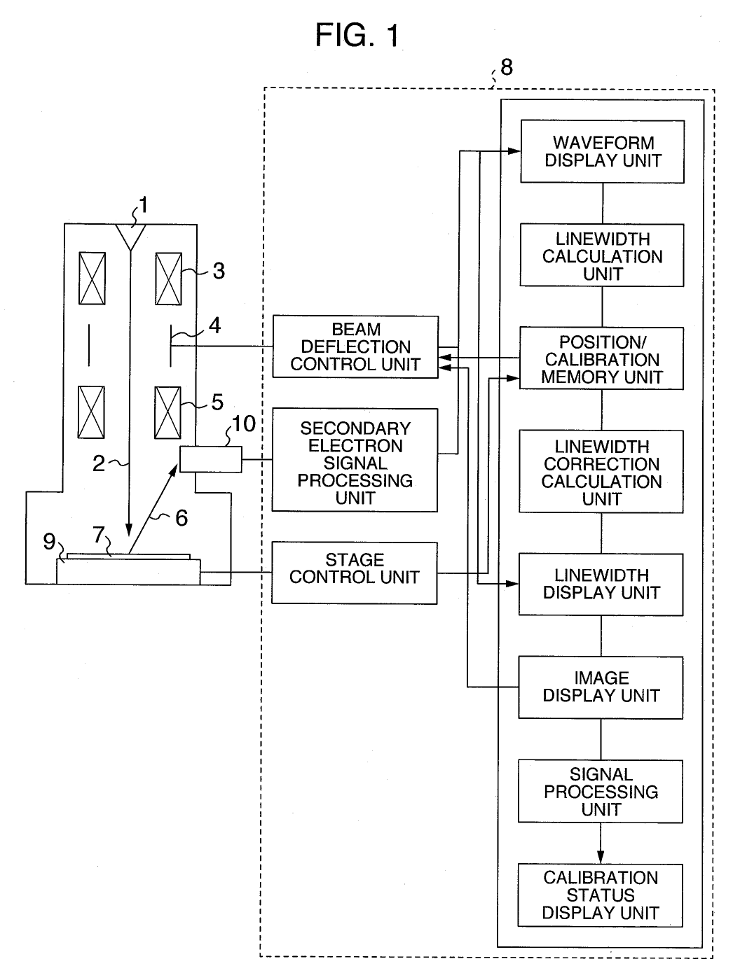

FIG. 1 shows a configuration of an electron beam metrology system used in an example. An irradiating optical system applies an electron beam 2 emitted from an electron gun (electron source) 1 onto a sample 7 through a deflecting system 4. A wafer 7 containing a calibration mark is placed on a stage 9. A secondary electron image or a secondary electron signal waveform is displayed and length measurement is performed on the basis of a signal from an electron detector 10 that detects secondary electrons 6 generated by electron beam irradiation by the irradiation optical system. The current position of the stage is detected and controlled by a stage control system. In FIG. 1, units such as calculating units, control units, and a display unit are contained in a control system 8. However, they do not necessarily need to be contained in the control system.

The diameters of semiconductor wafers used in real production recently have been increasing from 200 mm to 300 mm. It is difficult to form patterns on wafers having large diameters such as 300 mm by using electron beam lithography and laser interference lithography systems which form calibration patterns with a pitch of 200 nm or less to form patterns on wafers having large diameters as 300 mm because they can only carry and irradiate samples with limited sizes. Therefore, a calibration mark including a grating pattern is formed on a wafer having a smaller diameter and the pattern is transferred to a wafer having a larger diameter such as 300 mm. With this method, a calibration component having the same diameter as a large-diameter wafer can be fabricated.

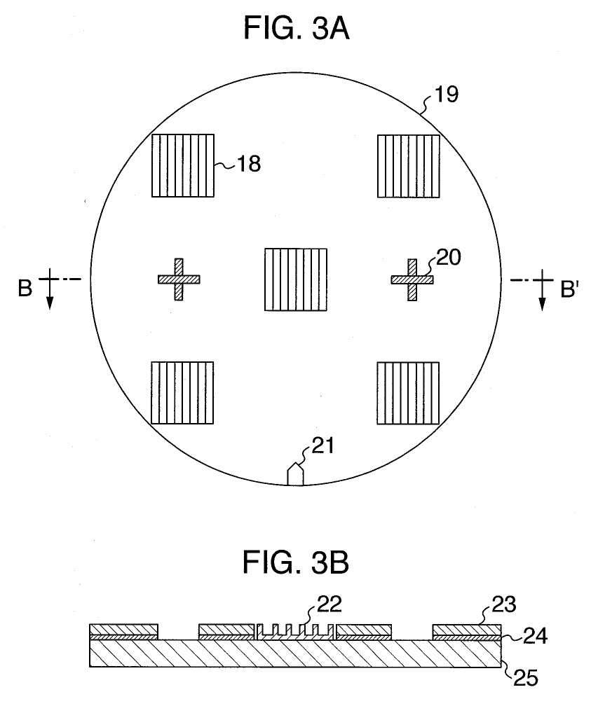

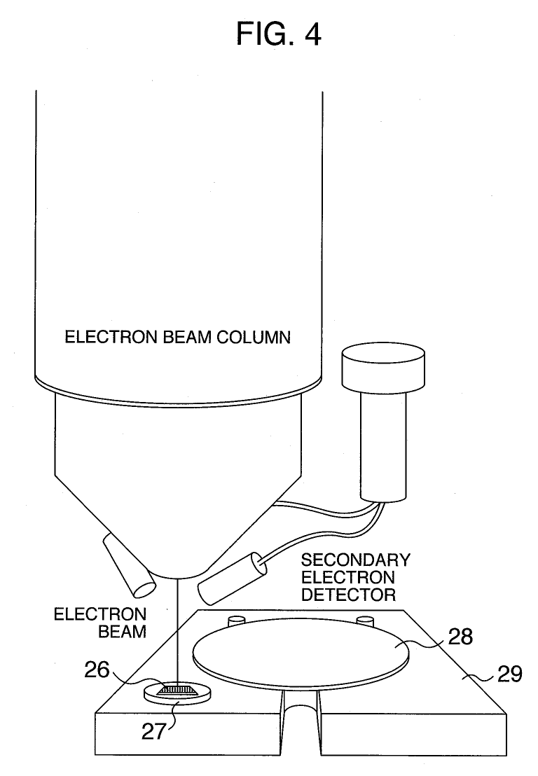

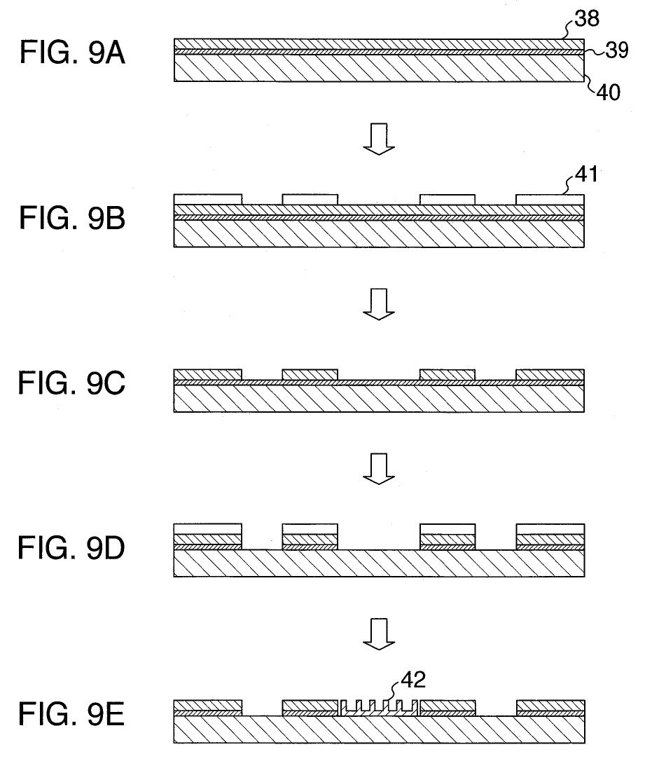

FIG. 3A shows a calibration component 19 having calibration marks including one-dimensional grating patterns formed on an SOI (bonding) substrate used in the present example. FIG. 3B shows an A-A′ cross-section of FIG. 3A. The calibration component is fabricated as shown in FIG. 9 and described below.

First, a bonding substrate with a diameter of 300 mm including a underlying silicon layer 40, an oxide layer 39, and an upper silicon layer 38 with thicknesses of 50 μm, 1 μm, and 725 μm, respectively, is provided as shown in FIG. 9A. Then, a resist is applied on the upper silicon layer 38 as shown in FIG. 9B. Then, as shown in FIG. 9C, a desired pattern is transferred onto the resist 41 through a mask. Alignment marks 20 shown in FIG. 9C are formed in desired positions on the wafer relative to a mark (a notch, for example) 21 shown in FIG. 3A, and the alignment marks 20 and a 15-mm-square region of the upper silicon layer 38 are etched away. During this etching, the oxide layer under the upper silicon layer 38 acts as an etch stop layer because the oxide layer has a tolerance to an etching agent such as CF agents. Then, as shown in FIG. 9D, the oxide layer 39 is etched away using an etching agent such as a hydrofluoric acid agent to which silicon has a tolerance. During this etching, the underlying silicon layer 40 acts as an etch stop layer because it has a tolerance to the etching agent used for etching off the oxide layer. A separately fabricated 12 mm-squared silicon chip 42 with a thickness of 50 μm on which a pattern consisting of a one-dimensional grating array is bonded onto the top surface of the underlying silicon layer in a 15 mm-squared region from which the oxide layer has been etched away as shown in FIG. 9E. Preferably, a conductive adhesive material is used in order to prevent the adhesion layer from being electrostatically charged. Because the thickness of the adhesive material is approximately 1 μm, the height of the one-dimensional grating pattern 22 on the wafer shown in FIG. 3B is in the range from 775 to 776 μm. Because a 300 mm diameter wafer used in semiconductor manufacturing lines is 775 μm in thickness, the difference between the wafer to be measured and the calibration component is less than 1 μm in height. Therefore, the calibration error is 0.5 nm or less. It should be noted that numeric values such as the thicknesses of the silicon layers are not limited to the specific values given above.

The calibration pattern may be attached onto the oxide layer without etching the oxide layer. However, in that case, the calibration pattern will be electrically insulated by the oxide layer and therefore can be electrostatically charged. Therefore, preferably a conductive layer is provided under the oxide layer or some means for removing electrostatic charge on the calibration pattern may be provided in the system. Instead of the oxide layer, a second conductive layer tolerant to the etching agent that can etch away silicon may be provided under the upper silicon layer (first conductive material layer) in order to prevent the calibration pattern from being electrostatically charged. Because the upper layer is made of silicon in the example described above, CF gas may be used for etching. A material such as tantalum or tungsten that has a tolerance to CF gas etching may be provided under the upper silicon layer. While an SOI substrate is used as a component on which calibration marks are formed in the example described above, the substrate is not limited to an SOI substrate. Any substrate with a multilayer structure including at least a fist layer of a material not tolerant to a given etching agent and a second layer of a material tolerant to the etching agent may be used. An example may be a structure in which an opening whose bottom is the surface of a first material layer is provided in the surface of a substrate including at least the first material layer and a second material layer provided on the first material layer or a substrate further including a third material layer provided on the second material layer, and a second substrate having a height approximately equal to that of the top surface of the substrate and having a calibration pattern formed in the opening is provided.

A method for calibrating the metrology system shown in FIG. 1 by using a standard sample according to the present embodiment will be described next. First, the stage 9 in FIG. 1 is moved to position a wafer-shaped standard component 7 containing a calibration mark right under the electron beam 2 in the same way a wafer to be measured is placed. A linewidth calculation unit calculates the pitch from a secondary electron signal waveform obtained by scanning a one-dimensional grating pattern perpendicular to the beam scan with an electron beam. Then, linewidth correction calibration unit compares the pitch obtained by the linewidth calculation unit with a pitch obtained in advance using an optical diffraction measurement method and stored in the memory unit and makes a correction to calibrate a beam deflection control unit in such a manner that the difference between the pitches becomes equal to 0.

In the case of a standard component placed on the stage in a conventional way, the difference between the height of the wafer 7 under measurement and that of a one-dimensional grating pattern was approximately 10 μm at maximum and accordingly the calibration error was 1 nm or more. Similarly, for a standard component in which a recess is formed in a wafer by machining or etching and a chip is embedded in the recess as described in SPIE Microlithography 4689-59, 2002, and a brochure of VLSI Standard Inc., the difference in height between the wafer and the one-dimensional grating pattern was in the order of 10 μm and a calibration error was 1 nm or more.

In contrast, in the wafer-shaped calibration component of the present invention, the difference between the height of the surface of a wafer under measurement placed and the height of the one-dimensional grating pattern of the wafer-shaped standard component is less than 1 μm and therefore a calibration error of 0.5 nm or less can be achieved. Furthermore, because the standard sample has a diameter approximately equal to that of a wafer under measurement, the standard sample can be loaded in and unloaded from the system through the same transfer route as a wafer under measurement without breaking vacuum, and beam calibration with high precision can be shared among multiple systems. Furthermore, the standard sample according to the present invention is not limited to the system shown in FIG. 1. The sample can be applied to beam calibration in other electron-beam-based systems.

According to the present example, the height and size of a calibration component can be made approximately equal to those of a wafer to be measured, therefore a highly precise beam calibration can be performed. Moreover, because the calibration mark can be properly placed at a position (including height) on a wafer at which measurement is to be performed, the electron beam system can be precisely calibrated. Furthermore, precise length measurement correction can be performed with high precision among multiple electron beam systems.

### SECOND EXAMPLE

Another exemplary configuration of a calibration sample according to another embodiment will be described below.

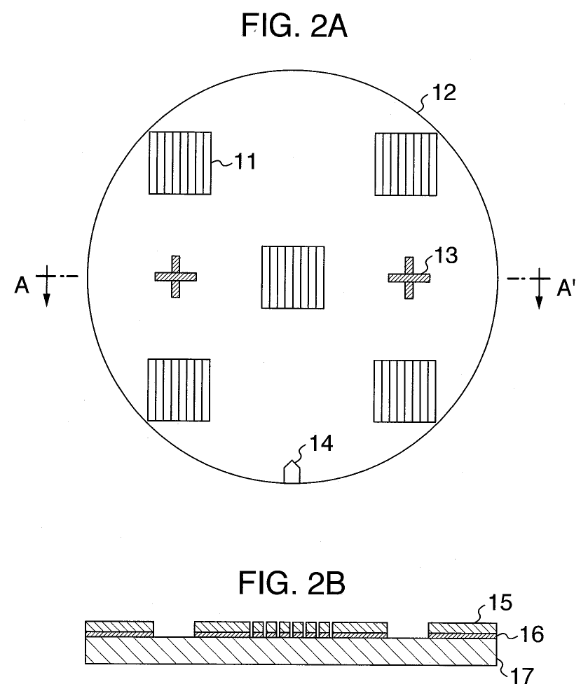

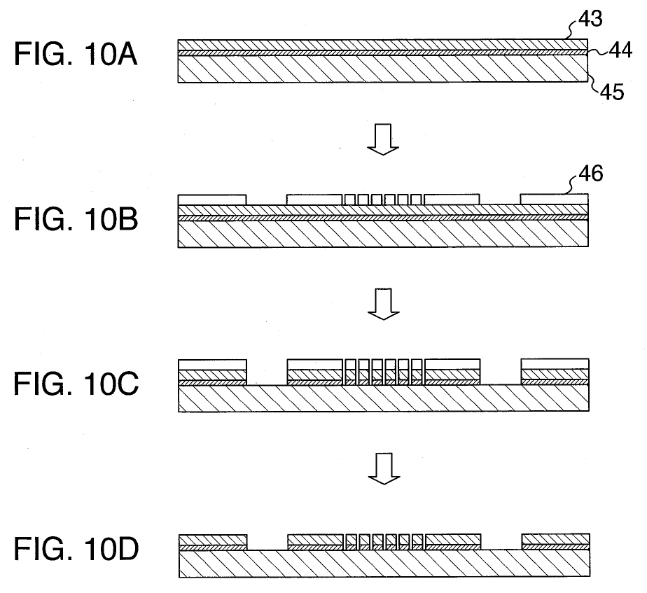

FIG. 2A shows a wafer 12 having at least one pattern of a one-dimensional grating array disposed in a desired position on SOI (bonding) substrate used in the second example. FIG. 2B show a B-B′ cross-section of FIG. 2A. The wafer is fabricated as shown in FIG. 10 and described below.

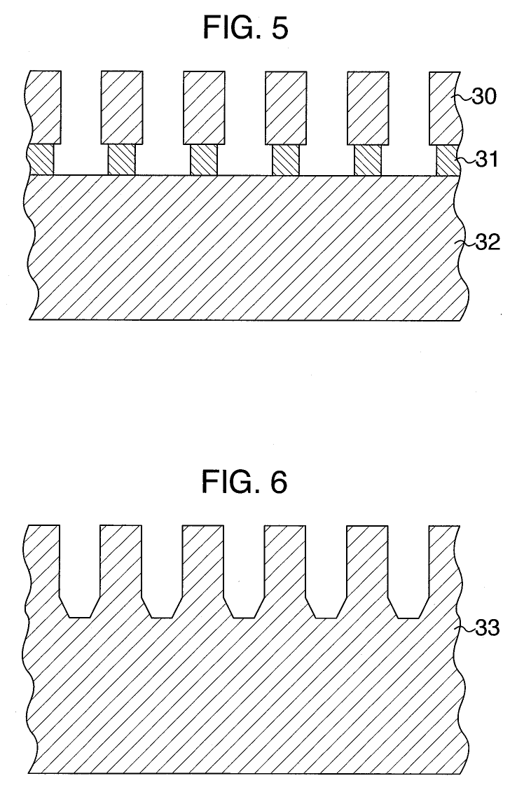

First, a bonding substrate having an underlying silicon layer 45 with a thickness of 100 nm, an oxide layer 44 with a thickness of 1 μm, and an upper silicon layer 45 with a thickness of 300 mm is provided as shown in FIG. 10A. Then, a polymeric resin is applied on the surface of the bonding substrate. In a desired position on the wafer relative to a mark (for example a notch) 14 shown in FIG. 2A for example, a silicon chip in which an alignment mark 13 and a calibration mark including a one-dimensional grating pattern are formed is used as a mold to imprint the calibration mark 11 including the one-dimensional grating pattern in the polymeric resin 46 as shown in FIG. 10B. The imprinted polymeric resin is then used as a mask to etch the upper silicon layer by using an etching agent to which the oxide layer 44 is tolerant. As shown in FIG. 10C, a rectangular cross-section with a uniform depth of 100 nm can be formed by the etching because the etching stops at the position where the oxide layer is exposed. Preferably, the exposed oxide layer 44 is then etched away as shown in FIG. 10D using an etching agent such as a hydrofluoric acid agent to which the underlying silicon layer is tolerant. This etching is performed to expose the underlying silicon layer 32 in such a manner that the oxide layer 31 is set back from the upper silicon layer 30 and is not visible from the upper surface as shown in FIG. 5.

In a conventional silicon layer 33 formed by a conventional dry etching process, the etched bottom is not flat as shown in FIG. 6 and therefore the upper and lower edges are seen when viewed from the upper surface. With the etching method of the second example, in contrast, a rectangular cross-section with a uniform depth of 100 nm in which the lower edges cannot be seen from the upper surface can be provided. It should be noted that numeric values such as the thicknesses of the silicon layers are not limited to the specific values given above. While the second example has been described with respect to an SOI substrate by way of example, the second example, as with the first example, is not limited to an SOI substrate. Instead, any substrate having a multilayer structure including a first material that does not have a tolerance to a given etching agent and a second material tolerant to the given etching agent can be used. An example may be a calibration component with a structure in which a calibration pattern having grooves are arranged at a predetermined pitch at the surface of a substrate including at least a first material layer and a second material layer provided on the first material layer or a substrate further including a third material layer provided on the second material layer and the bottom of the grooves is the surface of the first material layer.

In calibration, the stage in FIG. 1 is first moved to position the calibration mark right under an electron beam. At a linewidth calculation unit, the pitch is calculated from the signal waveform of secondary electrons obtained by scanning the one-dimensional grating pattern perpendicular to the beam scanning with the electron beam. Then, a linewidth correction calculation unit compares the pitch calculated by the linewidth calculation unit with a pitch obtained in advance by using an optical diffraction measurement method and stored in a memory unit and calibrates a beam deflection control unit by making a correction to the beam deflection control unit so that the difference becomes equal to 0.

In the conventional profile shown in FIG. 6, a pitch measurement standard deviation of 3 nm in the same position was resulted from erroneous recognition of the upper and lower edges in pitch measurement and therefore the average absolute precision of 20 samples was approximately 1 nm. By contrast, in the pitch measurement using the calibration component according to this example, there was not erroneous recognition of the lower and upper edges and the average deviation of variations in pitch measurement was less than or equal to 1 nm. Therefore, the average absolute precision of 20 samples on one surface was 0.5 nm or less.

Furthermore, when viewed from the upper surface, there are asperities on the one-dimensional grating pattern of the conventional calibration sample due to the influence of roughness associated with machining. Accordingly, the average deviation of variations in an area of approximately 1 nm square was 3 nm. In the present example, calibration samples are irradiated with laser light such as excimer laser in order to reduce the influence of the roughness. The laser irradiation did not cause any changes in the conventional structure because the heat of the irradiation diffused over the silicon substrate. In contrast, in the structure according to the present example as shown in FIG. 5, thermal diffusion is suppressed by the oxide film between the silicon layers and therefore the top silicon surface of the one-dimensional diffraction grating pattern melted, thereby reducing surface asperities. Thus, the average deviation of variations in an area of approximately 1 nm square decreased to less than or equal to 1 nm. Accordingly, an average absolute precision of 0.5 nm of 20 samples was achieved.

### THIRD EXAMPLE

A third example will be described below.

The calibration component 7 of the first or second example is used in calibration of an electron beam metrology system. First, the calibration component 7 is placed on the stage 9 in FIG. 1 and the stage 9 is moved to position a calibration mark formed on the calibration component 7 right under the electron beam. The wafer, namely the calibration component is mechanically held by pressure. A one-dimensional grating pattern perpendicular to the beam scanning is scanned with the electron beam. Secondary electrons generated by the irradiation with the electron beam are detected. The pitch is calculated from the signal waveform of detected secondary electrons by a linewidth calculation unit. A linewidth correction calculation unit compares the pitch calculated by the linewidth calculation unit with a pitch obtained in advance using an optical diffraction measurement method and stored in a memory unit and calibrates a beam deflection control unit by making a correction to the beam deflection control unit so that the difference becomes equal to 0.

A sufficient secondary electron signal contrast between the lines and grooves in a one-dimensional grating pattern is required during calibration. The depth of the groove of a calibration standard component is uniform and is determined by the thickness of the upper silicon layer. For example, when an electron beam system was calibrated with a low current such as 5 pA or less as in an ArF resist or low-k material, the secondary electron signal intensity decreases and therefore a sufficient contrast was not be able to be achieved. Consequently, the average deviation of the reproducibility of pitch measurement was 10 nm.

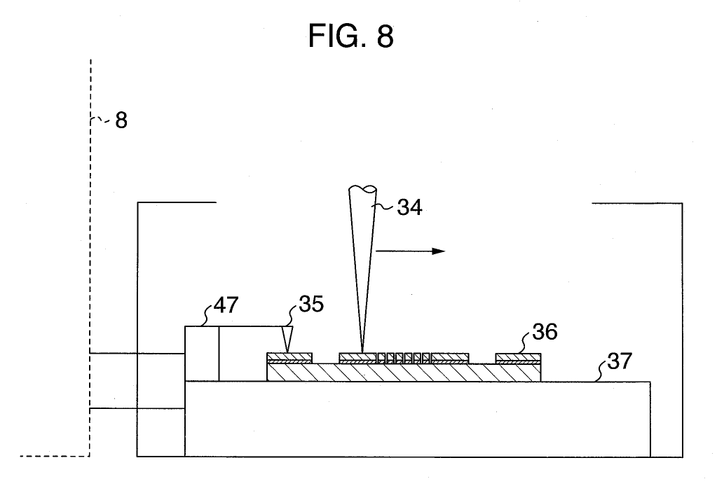

Therefore, as shown in FIG. 8, a constant voltage is applied to the surface of the upper silicon layer 36 on which the one-dimensional grating pattern is formed from a power supply 47 through a contact stylus 35. The voltage applied is controlled by a control system 8. While the power supply 47 is provided in the housing, it may be provided outside the housing or in the control system 8. As a result of the application of the voltage through the contact stylus, the average deviation of the reproducibility of pitch measurement decreased to 1 nm or less because the secondary electron signal intensity caused by an electric potential contrast between the upper silicon layer 36 and the lower silicon layer which was grounded at the stage 37 increased. The same effect was obtained by insulating the upper silicon layer using a contact stylus to accumulate an electron beam in the upper silicon layer over time.

### FOURTH EXAMPLE

A fourth example will be described below.

A calibration component 7 having multiple one-dimensional grating patterns according to the first or second example is used as a calibration sample for calibration of an electron beam metrology system. The calibration component 7 of the fourth example is held in an electron beam system using an electrostatic chucking. Although the wafer holding using electrostatic chucking equalizes the height of the wafers, it can cause electric field leakage near the edge of the wafer. As a result, an abnormal difference between the value measured in the center of the wafer to be measured and the value measured in the portion near the edge of the wafer under the influence of an electric field of electron beam deflection.

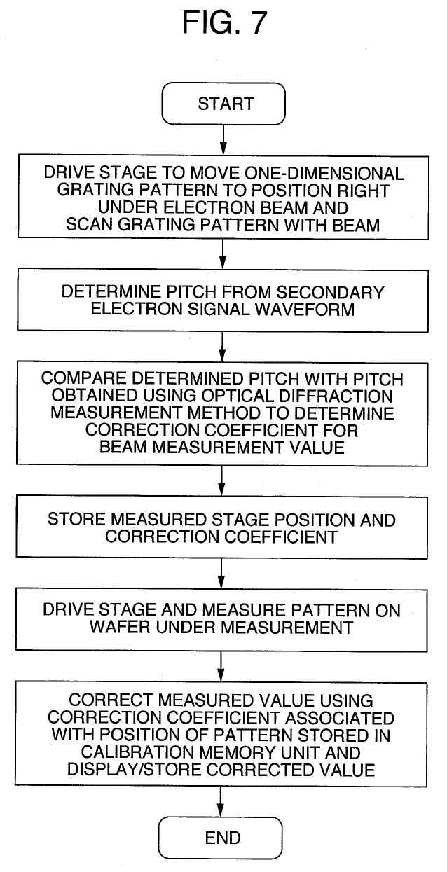

A calibration procedure will be described with reference to the examples in FIGS. 1 and 7. First, a calibration component 7 is placed on a stage 9, which is then moved so that any of multiple calibration marks 7 is positioned right under an electron beam. The wafer, namely the calibration component 7, is held by using electrostatic chucking. A one-dimensional grating pattern perpendicular to the beam scanning is scanned with the electron beam to obtain a pitch from a secondary electron signal waveform at a linewidth calculation unit. The pitch calculated at the linewidth calculation unit is compared with a pitch obtained using an optical diffraction measurement method by a linewidth correction calculation unit. A correction is made to a beam deflection control unit so that the difference becomes equal to 0, thereby calibrating the beam deflection control unit.

Then, the pitch of a calibration pattern placed at a different position is obtained using the above described method. This operation is performed for each calibration pattern. The pitches of the one-dimensional grating patterns thus obtained are compared and the calibration positions and correction coefficients at those positions are stored in a memory unit. The calibration positions and correction coefficients may be displayed on a display unit.

When length measurement is performed, the control unit calibrates corrects measurements on the basis of the stored calibration positions and correction coefficients. By providing a calibration pattern in multiple positions on a calibration component, a standard deviation of reproducibility of pitch measurement of less than or equal to 1 nm was obtained at any positions on the wafer to be measured.

According to the fourth example, measurements obtained by an electron beam system can be precisely corrected even if the measurements depend on positions in a wafer which differ from one sample holding method to another, because the calibration mark can be placed at multiple positions on the same wafer. While the fourth example has been described with respect to a holding method using electrostatic chucking, the same effect can be obtained by using other holding methods. For example, in the case of a fixing method using a mechanical pressure, calibration errors due to the influence of warpage of a wafer can be eliminated by disposing calibration patterns near the center of a calibration wafer and concentrically around the center of a wafer.

### FIFTH EXAMPLE

A fifth example will be described below in which the calibration component described in the above-described example is used for calibrating more than one systems.

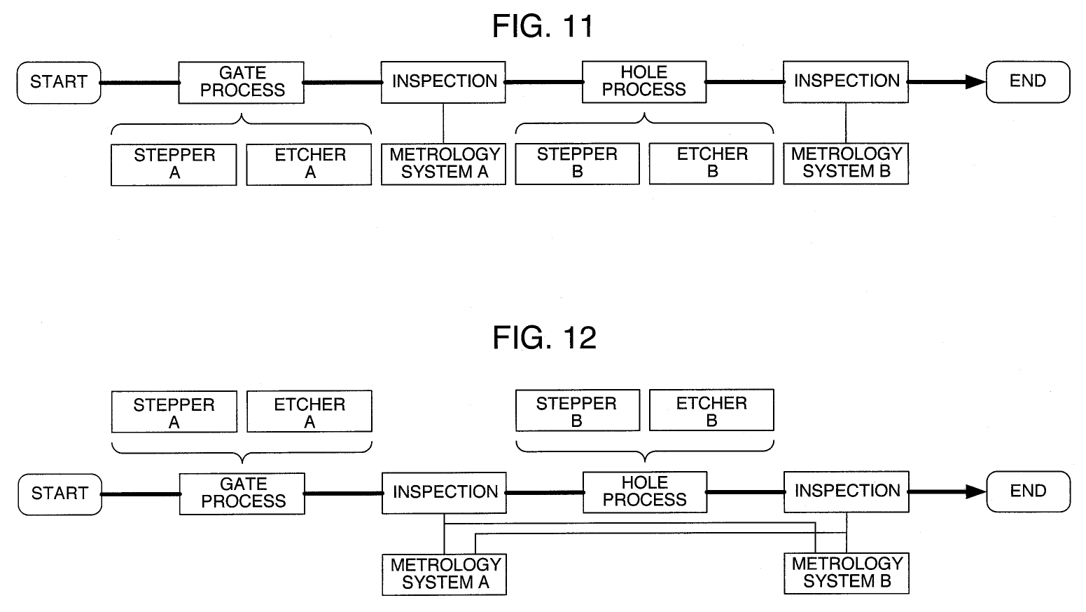

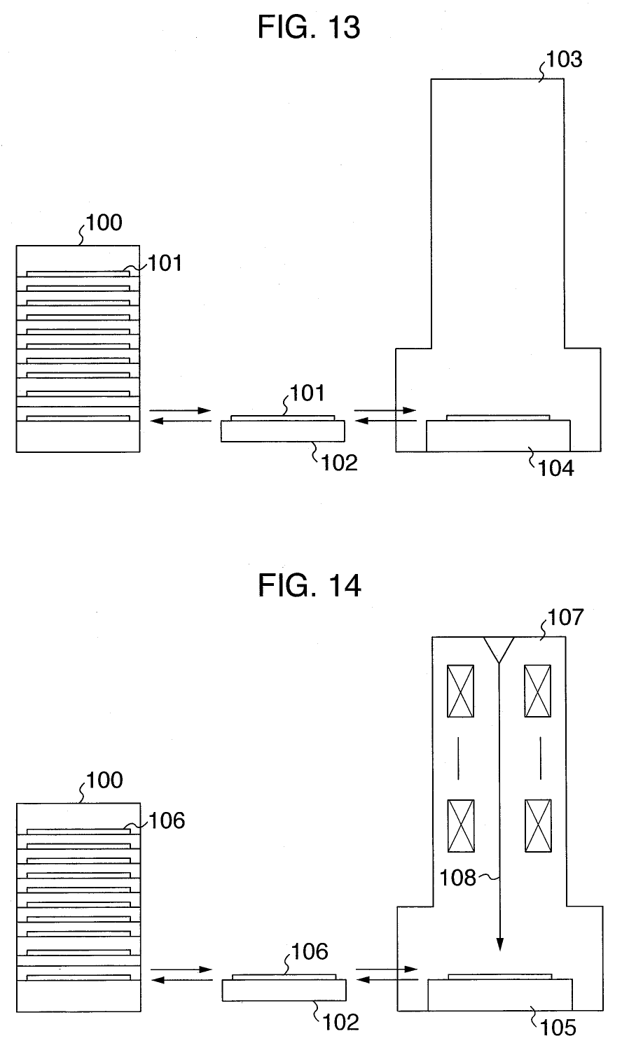

When semiconductor devices are manufactured, a number of wafers, for example 10 wafers, as shown in FIG. 13 are processed in the same manufacturing process as shown in FIG. 11. The 10 wafers are contained in a wafer cassette 100 and transported from one system to another. At each system 103, a transport robot 102 loads the wafers 101 from the wafer cassette 100 onto a stage 104 in the system. After one or a number of wafers are processed, the wafer or wafers are placed in the wafer cassette 100 by the transport robot 102 and transfers to the next system.

In a process for manufacturing semiconductor devices, processing is followed by an inspection as shown in FIG. 11. The inspection is conducted by using one or more electron beam metrology systems, for example electron beam metrology systems A and B as shown in FIG. 11. At each individual metrology system, correction is made by using a calibration component provided in that system. However, if the production capacity of a processing system (steppers A, B and etchers A, B) is high, a single inspection system in one inspection process may not be able to keep pace with processing. In such a case, the production capability varies depending on the throughput of the inspection system.

Therefore, multiple electron beam metrology systems A, B are used depending on the number of processed wafers in the fifth example as shown in FIG. 12. For example, if gate formation in 20 wafers and hole formation in 10 wafers have been completed, some of the wafers on which gates have been formed are inspected in metrology system B; on the other hand, if more wafers have undergone hole formation than the wafers that have undergone gate formation, some of the wafers that have undergone the hole formation are inspected in metrology system A.

If calibration components provided in the metrology systems are individually used to perform calibration, a difference between the calibration samples in the systems may result in a calibration error between the systems. The difference (in height for example) between calibration samples is typically of the order of 10 μm, which can result in a calibration error of approximately 1 nm in terms of measured linewidth error and poses a critical problem in high-precision measurement. A wafer-type standard component such as the one described in SPIE Microlithography 4689-59, 2002, and a brochure of VLSI Standard Inc. may be able to be used in multiple systems. However, because a one-dimensional grating pattern is embedded in the wafer, the method has a limited machining precision and therefore there is a height difference of approximately 10 μm.

Therefore, a wafer-shaped calibration component 106 having one-dimensional grating pattern provided on a multi-layer substrate consisting of a first material that does not have a tolerance to an etching agent and a second material that has a tolerance to that etching agent is used in the fifth example as shown in FIG. 14. First, calibration component is placed in a wafer cassette 100 and loaded by a transport robot 102 on a stage 105 of metrology system A 107. Calibration of the system is performed by using an electron beam 108. After the calibration, the calibration component is placed in the wafer cassette 100 by a transport robot 102 and transferred to metrology system B, where similar calibration is performed. As a result, differences in height position of the calibration sample among systems can be reduced to 1 micrometer or less and a calibration error of 0.5 nm or less among the systems can be achieved. Furthermore, the difference in height between a wafer to be measured and the calibration sample can be reduced to 1 μm or less and therefore a measurement error of less than or equal to 0.5 nm was achieved.

Because multiple metrology systems can be calibrated with the same precision in this way, many identical processed wafers can be allocated among the multiple metrology systems and inspected. Thus, efficient production can be achieved.

It should be further understood by those skilled in the art that although the foregoing description has been made on embodiments of the invention, the invention is not limited thereto and various changes and modifications may be made without departing from the spirit of the invention and the scope of the appended claims.

1. A standard component for length measurement calibration, comprising:
a substrate having at least a first material layer and a second material layer disposed on a surface of the first material layer; and
a calibration pattern having grooves arranged at a predetermined pitch on the surface of the substrate;
wherein the bottom of the grooves is the surface of the first material layer.

2. A standard component for length measurement calibration, comprising:
a first substrate having at least a first material layer and a second material layer disposed on a surface of the first material layer; and
a site of opening on the surface of the first substrate;
wherein the bottom of the opening is the surface of the first material layer and a second substrate on which a calibration pattern is arranged at a predetermined pitch is provided on the bottom of the opening.

3. The standard component for length measurement calibration according to claim 1, further comprising a third material layer disposed on the surface of the second material layer.

4. The standard component for length measurement calibration according to claim 1, wherein the second material layer is a conductive material layer.

5. The standard component for length measurement calibration according to claim 4, wherein the second material layer is a silicon layer.

6. The standard component for length measurement calibration according to claim 1, wherein the first material layer is an insulating layer or a conductive material layer different from the second material layer.

7. The standard component for length measurement calibration according to claim 1, wherein the first material layer is a silicon dioxide layer.

8. The standard component for length measurement calibration according to claim 3, wherein the third material layer is a conductive material layer.

9. The standard component for length measurement calibration according to claim 8, wherein the conductive material layer is a silicon layer.

10. The standard component for length measurement calibration according to claim 1, wherein the calibration pattern is formed in a plurality of positions on the substrate.

11. The standard component for length measurement calibration according to claim 2, wherein a plurality of the second substrates are provided in different positions on the first substrate.

12. The standard component for length measurement calibration according to claim 1, wherein the calibration pattern is a one-dimensional grating pattern.

13. The standard component for length measurement calibration according to claim 1, wherein the substrate is a wafer.

14. The standard component for length measurement calibration according to claim 2, wherein the first substrate is a wafer.

15. The standard component for length measurement calibration according to claim 13, wherein the diameter and height of the wafer are approximately equal to the diameter and height of a wafer under measurement.

16. A standard component for length measurement calibration, comprising a substrate including at least a first material layer having a tolerance to a first etching process, a second material layer disposed on a surface of the first material layer and is etchable by the first etching process, and a third material layer disposed on the second material layer, having a tolerance to the first etching process and is etchable by a second etching process,
wherein the substrate has a calibration pattern formed thereon, the calibration pattern being etched by the first and second etching processes to a position where the surface of the first material layer is exposed and being arranged at a predetermined pitch.
